(19) United States
(12) Patent Application Publication
(10) Pub. No.: US 2015/0058792 A1
(43) Pub. Date: Feb. 26, 2015

(54) METHODS, SYSTEMS AND APPARATUSES FOR PROVIDING USER INTERFACE NAVIGATION, DISPLAY INTERACTIVITY AND MULTI-BROWSER ARRAYS

(71) Applicants: Bernard KOBOS, Warsaw (PL); Daniel GELERNTER, Woodbridge, CT (US); Anthony ANDERSON, Chesterfield (GB)

(72) Inventors: Daniel GELERNTER, Woodbridge, CT (US); Anthony ANDERSON, Chesterfield (GB); Bernard KOBOS, Warsaw (PL)

(21) Appl. No.: 14/219,695

(22) Filed: Mar. 19, 2014

Related U.S. Application Data
(60) Provisional application No. 61/803,271, filed on Mar. 19, 2013.

(51) Int. Cl. G06F 3/0485; G06F 3/0484

(52) U.S. Cl. CPC G06F 3/0485; G06F 3/04842
USPC 715/784

(57) ABSTRACT

User input at an indicator area of a display responds to one or more of position, radius, speed, and angle of the input relative the indicator area to control display properties such as scroll and image perspective.

### CROSS REFERENCE TO RELATED APPLICATION

This application claims the benefit of U.S. provisional application Ser. No. 61/803,271, filed Mar. 19, 2013, the entire contents of which are hereby incorporated by reference herein.

### DESCRIPTION

Systems, methodologies and apparatuses for managing the presentation of information are described herein, with reference to examples and exemplary embodiments. Specific terminology is employed in describing examples and exemplary embodiments. However, the disclosure of this patent specification is not intended to be limited to the specific terminology so selected and it is to be understood that each specific element includes all technical equivalents that operate in a similar manner.

For example, the term “client computer system” or “client” as used in this application generally refers to a mobile device (cell phone, smartphone, tablet computer, ebook reader, etc.), computer (laptop, desktop, gaming console, etc.), television display (plasma, LCD, CRT, OLED, etc.) etc. including future technologies or applications enabling the same or similar results having sufficient input, storage, processing and output capabilities to execute one or more instructions as will be described in detail herein and as will be appreciated to those skilled in the relevant arts.

As another example, the term “server” generally refers to any one or more network connected devices configured to receive and transmit information such as audio/visual content to and from a client computer system and having sufficient input, storage, processing and output capabilities to execute one or more instructions as will be described in detail herein and as will be appreciated to those skilled in the relevant arts. For example, a “cloud server” may be provided which may not actually be a single server but may be a collection of one or more servers acting together as a shared collection of storage and processing resources. Such collection of servers need not all be situated in the same geographic location and may advantageously be spread out across a large geographic area.

An example of a client computer system is shown in FIG. 1. A client computer system 10 may include a processor 12, storage 14, a pointer input part 16, a spatial detector 18, a display 20 and a transceiver 22, or any combination thereof.

The term “processor” as used in this application generally refers to any electronic device or construction capable of being specifically programmed to execute programs or instructions. A suitable processor may be selected according to common knowledge in the art so as to have the processing power, power consumption, size, and/or cost attributes most desirable for a particular client.

The term “storage” as used in this application generally refers to any (one or more of) apparatus, device, composition, and the like, capable of retaining information and/or program instructions for future use, copying, playback, execution and the like. Some examples of storage include solid state storage devices, platter-type hard drives, virtual storage media and optical storage media formats such as CDs, DVDs and BDs, etc.

The term “position input part” as used in this application generally refers to any (one or more of) apparatus, device, composition, and the like, capable of receiving a user input specifying one or more positions on a display screen or a change in position(s) on a display screen. Examples of pointer input parts include a touch-sensitive display screen, a wired or wireless mouse, a stylus (with or without a complimentary stylus pad), a keyboard, etc. Further, position input parts may include physical buttons which may be displaced by some distance to register an input and touch-type inputs which register user input without noticeable displacement, for example capacitive or resistive sensors or buttons, a touch screen, etc. A pointer input part may also include, for example, a microphone and voice translation processor or program configured to receive voice commands

The term “spatial detector” as used in this application generally refers to any (one or more of) apparatus, device, composition, and the like, capable of detecting a spatial parameter related to the client. Examples of spatial parameters include acceleration and position in all directions. For example, applying a well known Cartesian coordinate system, acceleration and/or position of the client in the X, Y and/or Z directions may be detected by the spatial input part. Examples of spatial detectors include accelerometers, proximity sensors, GPS (Global Positioning System) receivers, LPS (Local Positioning System) receivers, etc. Spatial parameters may also be detected by specialized processing of data from one or more transceivers, for example by evaluating connections with multiple cellular communications towers to “triangulate” a position of the client, etc.

A communication transceiver may be a wired or wireless data communication transceiver, configured to transmit and/or receive data (which may include, for example, audio, video or other information) to and/or from a remote server or other electronic device. As an example, a wireless data communication transceiver may be configured to communicate data according to one or more data communication protocols, such as GSM (Global System for Mobile Communications), GPRS (General Packet Radio Service), CDMA (Code Division Multiple Access), EV-DO (Evolution-Data Optimized), EDGE (Enhanced Data Rates for GSM Evolution), 3GSM, HSPA (High Speed Packet Access), HSPA+, LTE (Long Term Evolution), LGE Advanced, DECT, WiFi™, Bluetooth™, etc. As one example, a wireless data communication transceiver may be configured to communicate data using an appropriate cellular telephone protocol to and/or from a remote internet server, for example, to communicate text, audio/visual and or other information to and/or from the client. As another example, a wired data communication transceiver may be configured to transmit and/or receive data over a LAN (Local Area Network) via a wired Ethernet connection and/or over a WAN (Wide Area Network) via a wired DSL (Digital Subscriber Line) or an optical fiber network.

A client may include one or more displays capable of displaying text or graphics. Examples of types of displays possibly comprised in a client include e-ink screens LCD (Liquid Crystal Display), TFT (Thin Film Transistor), TFD (Thin Film Diode), OLED (Organic Light-Emitting Diode), AMOLED (Active-matrix organic light-emitting diode) displays, etc. Displays may also include additional functionality such as touch sensitivity and may comprise or at least may communicate with the pointer input part. For example, the display of the client may include capacitive, resistive or some other type of touch screen technology. Generally, such touch screen technology is capable of sensing the position and sometimes even the force with which a user may touch the screen with one or more of their fingers or compatible implements.

In an aspect of the present application, a client may execute instructions tangibly embodied in storage, using a processor, to provide user interface navigation, display interactivity and multi-browser arrays. Such instructions are generally collectively referred to herein as a “program” for convenience and brevity.

In an aspect of the present application, shown in FIGS. 2A-2C, a display is configured to display an image thereon. The image may include textual elements, graphic elements, or a combination thereof. The image may be displayed at such a zoom level that not all of the image is displayable at one time. In this case, an image boundary 24 is larger than a display boundary 26, as shown in FIG. 2A. Conversely, the image may be displayed such that the image size matches the display size (shown in FIG. 2B) or is smaller than the display size (shown in FIG. 2C).

The image may be configured to be movable within the display, as shown in FIGS. 3A-3D. As shown in FIG. 3A, an image boundary 24 may be larger in a horizontal and vertical dimension than a display boundary 26. In one example, the display boundary 26 is moveable relative to the image boundary 24 (or vice versa) such that different portions of the image are displayed at any one time, as shown, for example, by the movement of display boundary 26 in both a horizontal and vertical direction between its position in FIG. 3A and its position in FIG. 3B relative to the image boundary 24. In the example shown in FIGS. 3C and 3D, image boundary 24 is the same width as display boundary 26, but the image boundary 26 has a larger vertical dimension than display boundary 26. In this example, display boundary 26 is moveable relative to the image boundary 24 (or vice versa) such that different horizontal “slices” of the image are displayed at any one time, as shown, for example, by the vertical movement of display boundary 26 between its position in FIG. 3C and its position in FIG. 3D relative to the image boundary 24. Throughout this application, such vertical movement may be generally referred to as “scrolling” while horizontal movement of a display boundary relative to an image boundary may generally be referred to herein as “panning.”

Panning and scrolling may be controlled by a user through operation of a navigation control 28 included in the client 10. A navigation control 28 may be a discrete component of the client 10, for example a physical wheel which may be rotated in one direction or the other by a user's finger, an optical, ball or nub type control operable by slight movements of a user's finger, a touch sensitive input such an a pressure or resistance sensing track pad operable by a swipe of a user's finger, etc. A navigation control 28 may overlap to some degree with a pointer input part 16. For example, a track pad normally used to register a location of a user's touch and translate that touch position to a position of a cursor on a display screen may be used as a navigation control. In one example, the simultaneous operation of a keyboard key (alt or Ctrl, for example) combined with an input from a pointer input part 16 may serve as a navigation control 28. In another example, a processor may be programmed or configured to process input from touch-sensitive display to control navigation of an image by panning and/or scrolling.

In one example of a navigation control, movement of a pointer (optionally combined with simultaneous operation of another user input such as a keyboard key or mouse button) may be configured to control navigation of a display boundary of a display relative to an image boundary of an image being displayed by the display. Such navigation control may be configured anywhere within the display boundary and may be confined to a predetermined portion of the display, or may be set to a particular portion of the display upon receipt of a user input. For example, a user may activate a predefined key or button, triggering establishment of the navigation control at a location of the pointer at that instant. Such a navigation control may be optionally configured to coincide with a complimentary graphic indicator displayed by the display. Such indicator may always be visible or its appearance may be triggered upon receipt of a command to establish the navigation control. Such navigation control indicator may be overlaid the image, partially or completely obscuring the image below it. Alternatively, a navigation control may be established which is not accompanied by a related indicator.

In one example of a navigation control, shown in FIGS. 4A and 4B, a graphic dial 30 is displayed by the display 20, either continuously or in response to a navigation control establishment command. Navigation may be controlled by movement of the pointer 32 relative to the graphic dial 30. As discussed above, movement of the pointer 32 may be required to be accompanied by another input such as a mouse click, a user touching the display, etc. in order to enable movement of the pointer to engage the navigation control. However, movement of the pointer 32 by itself may also be configured to engage the navigation control, for example in the case of a touch-sensitive display in which the display 20 also serves as a pointer input part 16. Additionally, a pointer 32 may or may not be graphically displayed during operation of the navigation control.

Operation of a dial-type navigation control is shown in Figures A and B. In the example shown, the navigation control is represented by a graphically displayed dial 30. Operation of the navigation control is described below in the context of a touch-sensitive display, although it will be understood, as discussed above, other types of pointer input parts may be similarly adapted for the same purpose. For example, a “click and drag” of a mouse may be configured to function similarly to a swipe of a touch-sensitive display. As shown in FIGS. 4A and 4B, a text document is displayed by the display, but is larger than the display boundary of the display. In response to a user touching the display at the position shown in FIG. 4A, a dial may be overlaid the background text. The location of the dial may be predefined or may be defined according to the location of the user's initial touch. In response to the user swiping their finger in a circular motion (shown by the dotted line 34 in FIG. 4B) while maintaining touch contact with the display, the text may be scrolled up relative to the display such that the upper portion of the text scrolls out of the display boundary while the lower portion of the text becomes visible. In the example shown, a clockwise swipe is configured to cause the displayed text to scroll up and a counterclockwise swipe is configured to cause the text to scroll down. However, it will be understood that an opposite swipe-to-scroll relationship may be configured. Of course, it will also be understood that the navigation controls described herein are applicable to images or text of any height or width. In another example, a second dial may be configured to control panning navigation of an image.

In another aspect, the speed of scrolling may also be controlled by a navigational control. A detailed view of a dial-type navigation control is shown in FIG. 5A. As a user swipes clockwise through angle θ from point of contact A to point of contact B, a radius from a center of the dial 30 increases from R1 to R2, as shown in FIG. 5B. The navigation control may be configured to have a negative correlation between radius of touch and scrolling speed, as shown in FIG. 5C. In such an example, the larger the radius of touch, the slower the text or image is scrolled. Alternatively, a direct correlation between radius of touch and scrolling speed may be configured.

In another example, the relationship between radius of touch and scrolling speed may be configured nonlinearly, as shown in FIG. 5D or may be configured to have a stepped relationship, as shown in FIG. 5E.

In another example, shown in FIG. 5F, a swipe of a user may be translated into scrolling or panning of text according to an angular displacement of the swipe. In the example shown, proportional angular displacement (X axis) is directly related to proportional displacement of text displayed on the display (Y axis). Proportional displacement of the text may be measured relatively by percentage. for example, if a page of text is 14 lines tall but the display boundary is only 5 lines tall, 10 lines will not be displayed at any one time. 0% scroll position is defined at the top of the text, when lines 1-5 are displayed and lines 6-15 are hidden. Accordingly, a 60% scroll position is defined as when text lines 6-11 are displayed. Similarly, proportional angular displacement may be measured relatively by percentage. For example, if a maximum swipe angle is defined at 180°, a 66° swipe could be measured as a 60% proportional angular displacement. In this example, even though a radius of touch may not be directly measured, a user swiping in a large radius will experience relatively slower scrolling speed than a user swiping with the same surface velocity (speed of the fingertip over the display surface) at a smaller radius.

In another aspect of the present application, scroll (or pan) position may be indicated by one or more scroll (or pan) position indicators 36, as shown in FIG. 6. In the example, shown, a first indicator area 38 may indicate a total amount of text above the currently displayed portion of text, while a second indicator area 40 may indicate an amount of text below the currently displayed portion of text. The amount of text above or below the currently displayed portion of text may change dynamically, as a result of operation of a navigation control or, for example, as a result of additional text being downloaded from a remote location and added to the text document dynamically. Also shown in FIG. 6, one or more bookmarks 40 may be displayed on the indicator 36. Activation of a bookmark by a pointer input part may result in the display “jumping” to the predefined location in the text or image associated with the bookmark. In another example, more than one indicators may be displayed in a particular area of the display, allowing further information to be conveyed by the position of the indicators relative to one another. Such indicators may be layered over one another and/or may be distinguished by size, color, transparency, etc. In a further example, an indicators or indicators may coincide with or be oriented around a dial-type navigation control.

In another aspect of the present application, input from a client's spatial detector may be processed to alter a perspective of an image displayed by a display. In this way, the client, particularly if it is a mobile client such as a smartphone to tablet computer, may be configured to give the illusion that the display of the client is a “window” into a three dimensional digital world.

This aspect is shown in FIGS. 7A-7D. On the left side of the figures, a representative depiction of a client 10 is shown and on the right side of the figures, a representative depiction of a display 20 displaying a dynamic image of a three dimensional object 44 is shown. A directional nomenclature is shown in FIG. 7A, wherein the positive Y direction extends into the page. As shown in FIG. 7A, a client is held by a user facing directly towards them. This initial “home” position may be preset, calculated by processing average spatial data during use, set manually by the user, etc. As shown in the display to the right, the image of the object 44 is depicted in a head-on orientation, optionally with an amount of perspective applied to the image which may result in a small portion of the top, bottom or sides of the objects being shown.

In FIG. 7B, the client is rotated about the Z axis towards the left hand side of the user. The spatial detector is configured to detect the change in position and information from the spatial detector regarding the change is processed to re-configure the image of the object 44 displayed by the display. As shown, the object may be virtually rotated in the same direction as the client. The amount of rotation may be configured to mimic the amount of rotation of the client or the amount of rotation of the object may be configured as a multiple or fraction of the amount of rotation of the client. FIG. 7C shows the result of a similar rotation of the client about the Z axis towards the user's right hand side.

In FIG. 7D, the client is tilted away from the user about the X axis so that the top of the client is further away from the user than the bottom of the client. As shown on the right side of FIG. 7D, a corresponding backwards tilt of the object 44 is processed and displayed.

It will be understood that a rotation or tilt about any combination of axes may be similarly processed. For example, the client may be tilted about the X and Z axes, X, Y and Z axes, etc. relative to the home orientation. The processor may be configured to continuously detect, via the spatial detector, changes in orientation of the client and process an image accordingly.

An image need not be input or stored as a three dimensional object to be processed and virtually rotated or titled. For example, a two dimensional image or text may be subjected to three dimensional processing to give the image a third dimension before rotation/tilt processing is begun. For example, a two dimensional rectangular block of text may be processed by a three dimensional processor to convert the two dimensional rectangle to a three dimensional rectangular box or prism.

In another aspect of the present application, a client may be configured to display multiple functional miniature website browser windows simultaneously, to allow a user to keep track of and to independently browse many websites at the same time.

In one example, shown in FIG. 8, an application window 46 is displayed on a client display and is configured to include a series of websites the user is interested in 48a-d. Each website is not merely thumbnailed; rather, each website is run in miniature, allowing it's links, text-fields, buttons and similar controls to be operable, which in turn allows the user to browse the web from inside each miniature window 48a-d. The miniature websites continue to respond to real-time updates, just as a website in a full browser would. An optional “new URL control” 50 allows users to enter new websites to be displayed by the app. Alternately, a user may add websites to the app by clicking and dragging URLs or favicons from other browsers and dropping them into the app area.

In a further example, mini-browser controls 52 may become available when a particular one of the websites (48b, for example)has been given “focus,” allowing the user to perform a wide array of browsing activities (including but not limited to navigating, searching, refreshing, and returning “home”). A focus of a website may be graphically indicated, for example by a different border (an example of which is shown around mini-browser 48b), changing a size of the mini-browser (for example, if mini-browser 48c without focus is displayed the size of min-browser 48a, but grows to its depicted size upon receiving focus) relocating a mini-browser (for example if mini-browser 48a were to relocate to the space occupied by min-browser 48d upon receiving focus), etc.

As still another example, artificial intelligence may be implemented to bring important websites or websites seeking recognition to the attention of the user. For example, the user may be using a client to keep track of more websites than can fit into the application window 46. In this example, a website which is not currently being displayed can be promoted into the viewable area when some event of importance has occurred (for example, when a significant update has been made to the website). Alternately, a cycle may established automatically or manually by the user whereby websites are promoted to visible places on the screen with a certain recurring frequency (every two hours, for example) or when certain other criteria have been met. For example, the user may configure the client to present a website showing the news in New Haven, Conn. when a GPS location system on his device indicates that he is in or close to New Haven.

In addition, the embodiments and examples above are illustrative, and many variations can be introduced to them without departing from the spirit of the disclosure or from the scope of the appended claims. For example, elements and/or features of different illustrative and exemplary embodiments herein may be combined with each other and/or substituted for each other within the scope of this disclosure.

### BRIEF DESCRIPTION OF THE DRAWINGS

FIG. 1 illustrates a client computer system.

FIG. 2A illustrates a display with an image boundary larger than a display boundary. FIG. 2B illustrates a display with an image boundary that matches a display boundary. FIG. 2C illustrates a display with an image boundary smaller than a display boundary.

FIGS. 3A and 3B illustrate a display with an image boundary larger in a horizontal and vertical dimension than a display boundary. FIGS. 3C and 3D illustrate a display with an image boundary the same width as a display boundary but the image boundary has a larger vertical dimension than the display boundary.

FIGS. 4A and 4B illustrate a text document displayed by the display.

FIG. 5A illustrates a dial-type navigation control. FIG. 5B shows a graph of the relationship between radius and angle. FIG. 5C shows a graph of the relationship between scrolling speed and angle. FIGS. 5D and 5E show graphs of the relationship between scrolling speed and radius. FIG. 5F shows a graph of the relationship between text and angle.

FIG. 6 illustrates scroll position indicators.

FIGS. 7A-7D illustrate perspectives of an image displayed by a display.

FIG. 8 illustrates an application window displayed on a client display configured to include a series of website browser windows simultaneously.

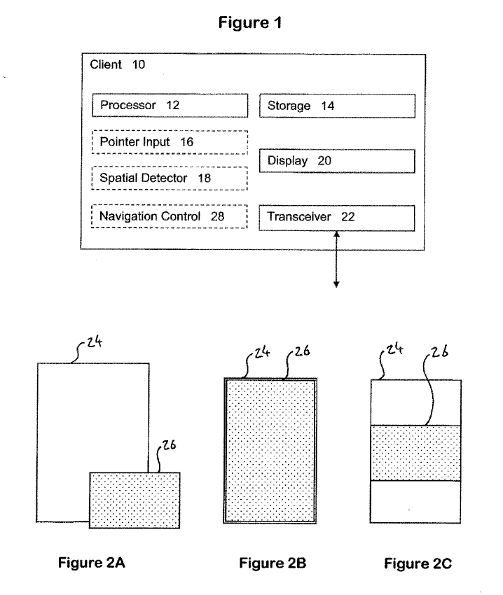

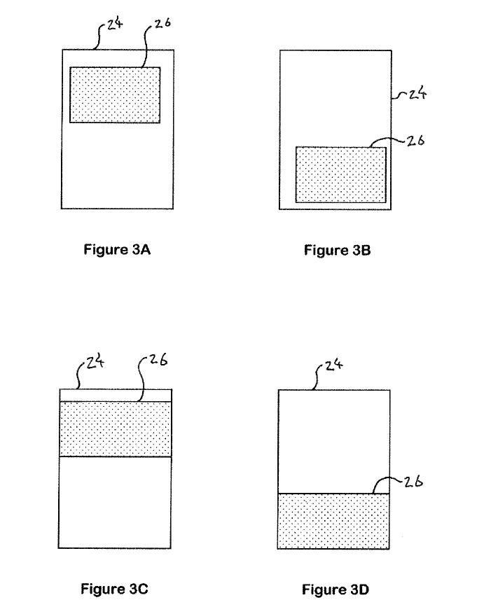

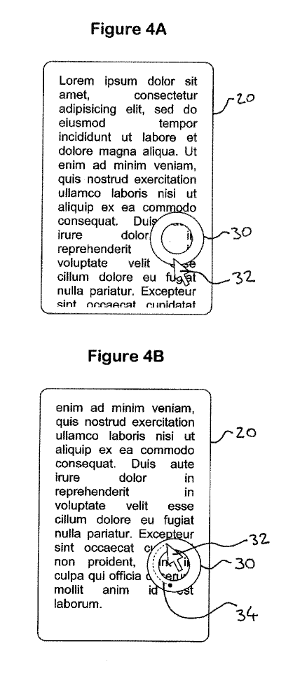

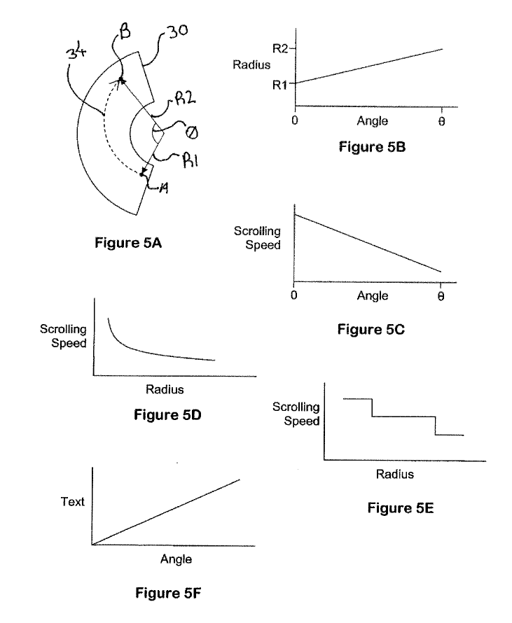

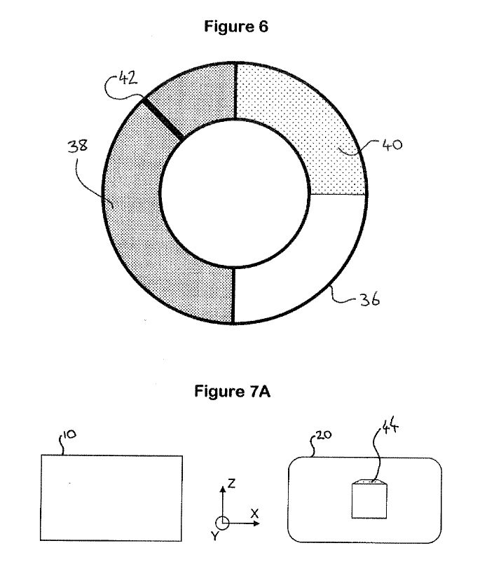

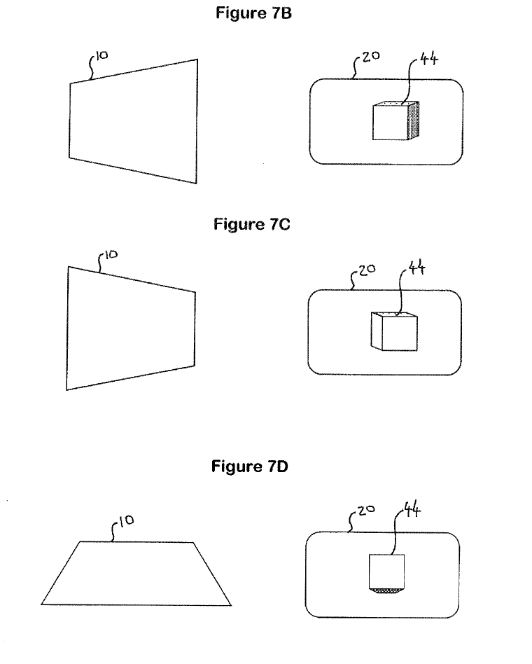

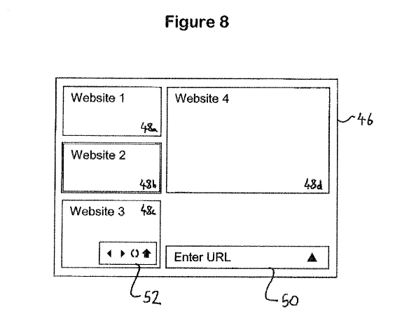

What is claimed is:

1. A computer-implemented method of controlling properties of a displayed image through user input at an indicator area of a computer display, comprising:
providing a computer display with rounded area, of segments of position indicators;
detecting user Interaction with the position indicators to thereby generate electronic signals indicative at least of position of the interactions relative to the position indicators, speed of the interactions relative to the indicators, direction of the interactions relative to the indicators, and angular information of the interactions relative to the indicators;
generating display-control electronic signals representative of the interactions; and
controlling the display of an image on a computer display-according to the display-control signals to modify image parameters including position of the image on the display, scrolling direction of the image, scrolling speed of the image, and perspective of the image.

2. A computer program stored in non-transitory for on computer-readable media and comprising computer instructions which when loaded into a computer and executed by the computer carry out the steps of:
showing on a computer display a rounded area of segments of position indicators;
responding to user interaction with the position indicators to thereby generate electronic signals indicative at least of position of the interactions relative to the position indicators, speed of the interactions relative to the indicators, direction of the interactions relative to the indicators, and angular information of the interactions relative to the indicators;
generating display-control electronic signals representative of the interactions; and
controlling the display of an image on a computer display according to the display-control signals to modify image parameters including position of the image on the display, scrolling direction of the image, scrolling speed of the image, and perspective of the image.

3. A computer system comprising:
a computer display;
a display facility configured to show on the computer display a rounded area of segments of position indicators;
a detection facility configured to respond to user interaction with the position indicators to thereby generate electronic signals indicative at least of position of the interactions relative to the position indicators, speed of the interactions relative to the indicators, direction of the interactions relative to the indicators, and angular information of the interactions relative to the indicators;
a control facility associated with the detection facility and configured to generate display control electronic signals representative of the interactions; and
a display driving facility coupled with the control facility and with the computer display and configured to control the display of an image on the computer display according to the display-control signals to modify image parameters including position of the image on the display, scrolling direction of the image, scrolling speed of the image, and perspective of the image.
